(19) United States
(12) Patent Application Publication
(10) Pub. No.: US 2010/0212688 A1
(43) Pub. Date: Aug. 26, 2010

(54) FLUID HEATING SYSTEM FOR A CLEANING DEVICE

(76) Inventor: Sean K. Goff, Bristol, WI (US)

Correspondence Address: QUARLES & BRADY LLP, 411 E. WISCONSIN AVENUE, SUITE 2040, MILWAUKEE, WI, 53202-4497, US

(21) Appl. No.: 12/393,742

(22) Filed: Feb. 26, 2009

(51) Int. Cl. B08B 3/10

(52) U.S. Cl. 134/6; 134/107

(57) ABSTRACT

A cleaning device comprises a frame and a tank carried by the frame that contains a cleaning fluid. A first motor is capable of generating a first motor heat. A passageway is in fluid communication with the tank and is in thermal communication with the first motor to transfer at least a portion of the first motor heat to the cleaning fluid when the cleaning fluid is directed downstream from the tank through the passageway. An outlet is in fluid communication with the passageway and downstream of the first motor to direct the cleaning fluid onto a surface to be cleaned.

### CROSS REFERENCES TO RELATED APPLICATIONS

Not Applicable.

### STATEMENT REGARDING FEDERALLY SPONSORED RESEARCH

Not Applicable.

### BACKGROUND OF THE INVENTION

The present invention relates generally to cleaning devices, and more particularly to a fluid heating system for use in a cleaning device.

Cleaning devices are available to perform a variety of functions in various settings. For example, a self-propelled floor scrubber may be used to clean and maintain a factory floor. The floor scrubber may include a variety of implements, that is, brooms, scrubbers, vacuums, and the like to perform the cleaning operations. As another example, a walk-behind sweeper may be used to gather debris using a combination of sweepers and vacuums. Cleaning devices also come in a variety of drive types, such as, self-propelled (both walk behind and ride-on) and push- or pull-type, and often use an electric power source (e.g., batteries) to drive electric motors. Alternatively, or in addition to the electric power source, the cleaning device may incorporate a liquid propane engine, or some other type of power source, to power the cleaning device.

Regardless of the power source used, many cleaning devices are limited in the amount of on-board energy the cleaning device may store and thus use during the cleaning operation. For example, battery powered cleaning devices are limited by a storage capacity that can provide a certain amount of amp-hours to perform the cleaning tasks. When the on-board energy is depleted, the cleaning device must be re-powered by, for example, recharging the on-board batteries, exchanging the depleted batteries for charged batteries, re-filling a gas storage tank (e.g., a propane tank), or some other technique. As a result, the efficiency of the cleaning device (i.e., the power consumption versus cleaning capacity) is a metric used to evaluate various cleaning devices.

The limited energy storage capacity of typical cleaning devices presents additional limitations in terms of achieving a thorough cleaning. Specifically, heated or warmed cleaning fluid (i.e., the fluid used in a scrubber to clean the surface or in a sweeper to control airborne particles, for example) tends to be more effective in breaking down, removing, and controlling grime, dirt, stains, and other debris. However, conventional methods of warming the cleaning fluid, for example an electric element located within the cleaning fluid storage tank, further depletes the available energy to operate the cleaning device. As a result, current cleaning devices must balance cleaning capacity and overall efficiency with power consumption and effectiveness.

In light of at least the above considerations, a need exists for a cleaning device that incorporates an efficient system for warming cleaning fluid while having a minimal impact on the operational capacity of the cleaning device.

### SUMMARY OF THE INVENTION

In one aspect, a cleaning device comprises a frame and a tank carried by the frame that contains a cleaning fluid. A first motor is capable of generating a first motor heat. A passageway is in fluid communication with the tank and is in thermal communication with the first motor to transfer at least a portion of the first motor heat to the cleaning fluid when the cleaning fluid is directed downstream from the tank along the passageway. An outlet is in fluid communication with the passageway and downstream of the first motor to direct the cleaning fluid onto a surface to be cleaned.

In another aspect, a cleaning device comprises a frame, a deck operationally coupled to the frame, and a tank carried by the frame and containing a cleaning fluid. A first motor is capable of generating a first motor heat. A passageway is in fluid communication with the tank and in thermal communication with the first motor to transfer at least a portion of the first motor heat to the cleaning fluid when the cleaning fluid is directed downstream from the tank along the passageway. An outlet is in fluid communication with the passageway and downstream of the first motor to direct the cleaning fluid onto a surface to be cleaned.

In yet a further aspect, a method of cleaning a surface with a cleaning device having a frame, a tank carried by the frame and containing a cleaning fluid, a motor capable of generating a motor heat, a passageway in fluid communication with the tank and in thermal communication with the motor, and an outlet in fluid communication with the passageway and downstream of the motor, comprises the step of transferring at least a portion of the motor heat to the cleaning fluid as the cleaning fluid flows downstream from the tank along the passageway.

These and still other aspects of the invention will be apparent from the description that follows. In the detailed description, example embodiments will be described with reference to the accompanying drawings. These embodiments do not represent the full scope of the invention; rather the invention may be employed in other embodiments as will be appreciated by one skilled in the art given the benefit of the present disclosure. Reference should therefore be made to the claims herein for determining the full scope of the invention.

### BRIEF DESCRIPTION OF THE DRAWINGS

FIG. 1 is an isometric view of an example cleaning device;

FIG. 2 is a partial isometric view of an example fluid heating system;

FIG. 3 is a simplified schematic of an example fluid heating system;

FIG. 4 is a simplified schematic of another example fluid heating system;

FIG. 5 is a simplified, partial cross-section of a portion of an example fluid heating system;

FIG. 6 is a simplified, partial cross-section of a portion of a further example fluid heating system;

FIG. 7 is a simplified, partial cross-section of a portion of another example fluid heating system;

FIG. 8 is a simplified, partial cross-section of a portion of a further example fluid heating system; and

FIG. 9 is a simplified, partial cross-section of a portion of a still another example fluid heating system.

### DETAILED DESCRIPTION OF EXAMPLE EMBODIMENTS

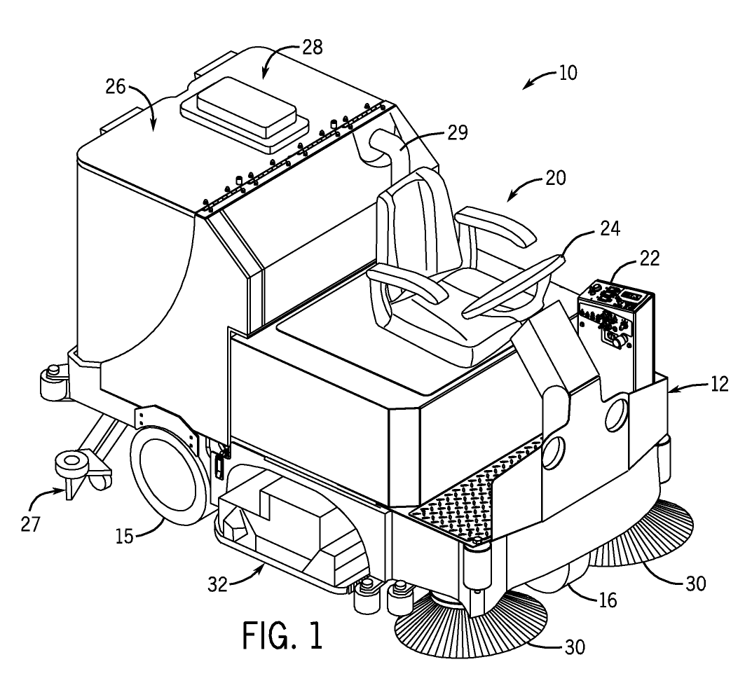

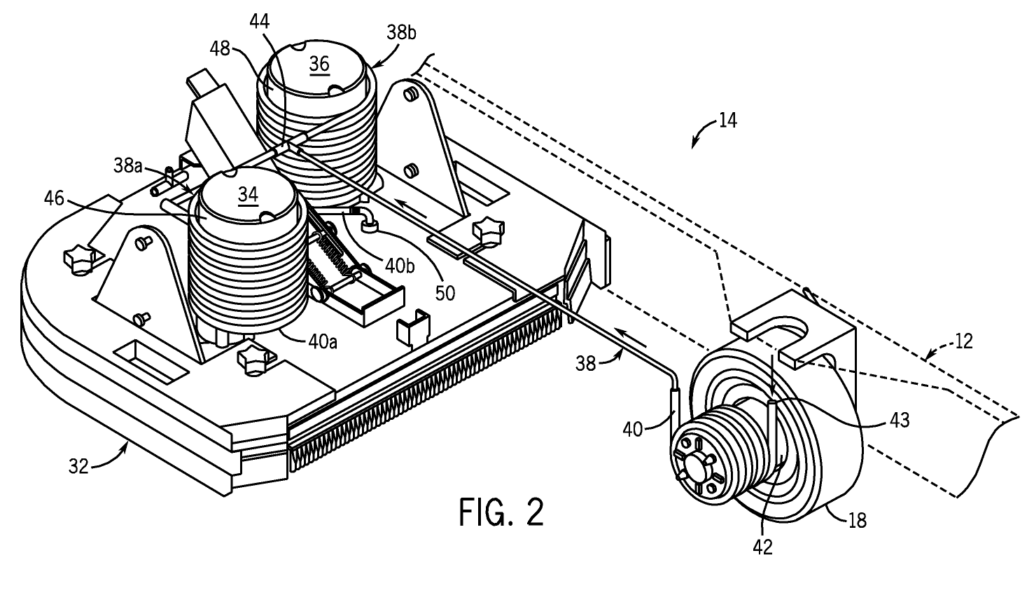

A cleaning device 10, in the form of a floor scrubber, is shown in FIG. 1. While the example cleaning device 10 is depicted and described as a ride-on floor scrubber, the various aspects of the fluid heating system 14 (an example of which is shown in simplified form in FIG. 2) are similarly applicable to other types and styles of cleaning devices. For example, the general fluid heating system 14 is equally applicable for use with sweepers that collect debris. Additionally, the cleaning device may be self-propelled (e.g., ride-on and walk-behind), push- or pull-type (e.g., either by an operator or another vehicle), or any combination thereof.

With continued reference to FIG. 1, the example cleaning device 10 is shown as a ride-on floor scrubber. The cleaning device 10 includes a frame 12 that supports a pair of rear wheels 15 and a single front wheel 16. The front wheel 16 is both driven by a drive motor 18 (shown in FIG. 2) and steerable. An operator compartment 20 includes a control stack 22, a steering wheel 24, and foot pedals (not shown), the combination of which allow the operator to control the operation of the cleaning device 10.

A solution tank 26 and a recovery tank 28 are carried by the frame 12. The solution tank 26 is configured to contain a cleaning fluid, such as a combination of water, chemicals, solvents, and the like. The terms “cleaning fluid” and “fluid” are intended to encompass various types of liquids, gels, pastes, and the like having a variety of chemical compositions, including common tap water. The fluid is preferably extracted from the solution tank 26 via a pump (not shown), but may also be motivated by a gravity-feed arrangement. A squeegee 27 extends from the rear of the cleaning device 10 and directs the spent fluid (i.e., fluid that has been applied to the surface to be cleaned) toward a vacuum section (not shown). An implement motor (not shown) (e.g., a vacuum motor) draws the spent fluid through a return line 29 where it is ultimately directed into the recovery tank 28. In addition, a pair of side brushes 30 are coupled to the forward corners of the frame 12 and are rotated by implement motors (not shown) to direct debris toward the center of the cleaning device 10 and agitate the surface to be cleaned.

With additional reference to FIG. 2, a scrubber deck 32 of the example embodiment supports a first implement motor 34 and a second implement motor 36. Each implement motor 34, 36 is coupled to a respective scrubber disk (not shown) adjacent the underside of the scrubber deck 32 that engages and agitates the surface to be cleaned. In addition, the drive motor 18 is shown coupled to the frame 12 and is operationally coupled to the front wheel 16 in any manner known to one of ordinary skill.

One skilled in the art will appreciate that any type of motor may be used to operate the cleaning device 10, that is, power the implements (e.g., brushes, scrubber disks, etc.) and the propulsion system. In the example embodiment, the implement motors 34, 36 and the drive motor 18 are electric motors, however, given the benefit of this disclosure, one skilled in the art will appreciate that the claimed invention is compatible with a variety of motor types (e.g., internal combustion) and arrangements.

Whichever type of motor is incorporated in the cleaning device 10, each generates heat during use. In the case of the example electric motors, heat is generated in part due to electrical resistance of the wound coils and mechanical resistance of the internal rotor. The fluid heating system 14 is configured to extract at least a portion of the heat generated by the motors to increase the temperature of the fluid as it travels from the solution tank 26 downstream toward the scrubber deck 32 before the fluid is directed onto the surface to be cleaned.

With continued reference to the example fluid heating system 14 shown in FIG. 2, a passageway 38 is defined by a conduit 40 (e.g., a thermally conductive tubing) that is wrapped about the drive motor 18 and the implement motors 34, 36. The conduit 40 is shown removed along a portion of the passageway 38, exposing the fluid flowing within the conduit 40 in the direction of the arrows shown in FIG. 2. The passageway 38 is in fluid communication with the solution tank 26 (not shown in FIG. 2) proximate an upstream end 43. As the fluid flows downstream along the passageway 38, the passageway 38 is in thermal communication with the drive motor 18 such that at least a portion of the heat generated by the drive motor 18 is transferred to the fluid, thereby raising the temperature of the fluid in the passageway 38 relative to the temperature of fluid residing in the solution tank 26. As shown in FIG. 2, the portion of the conduit 40 that is proximate the drive motor 18 is preferably tightly coiled such that the conduit 40 is in engagement with or proximate to an exterior surface 42 of the drive motor 18 and little to no gap exists between adjacent coils of the conduit 40.

Continuing to follow the flow of fluid downstream along the passageway 38 leads to a T-divider 44 that splits the incoming flow of warmed fluid to one of the first implement motor 34 and the second implement motor 36, thus dividing the passageway 38 into a first passageway 38a and a second passageway 38b and the conduit 40 into a first conduit 40a and a second conduit 40b. Similar to the drive motor 18, the implement motors 34, 36 each generate heat, a portion of which is transferred to the fluid as the passageways 38a, 38b wrap around the respective implement motors 34, 36. The first conduit 40a wraps around the first implement motor 34 and is proximate an external surface 46 of the first implement motor 34. Similarly, the second conduit 40b also wraps around the second implement motor 36 proximate an external surface 48 of the second implement motor 36. The conduits 40a, 40b are shown with minimal clearance between adjacent wraps of the respective conduits 40a, 40b about the respective implement motors 34, 36 to maximize the thermal communication and interaction between the fluid flowing along the passageways 38a, 38b and the implement motors 34, 36.

Each passageway 38a, 38b defines a downstream outlet 50 (only one is illustrated in FIG. 2). The outlet 50 is configured to direct the warmed fluid onto the surface to be cleaned, therefore providing an improved cleaning action as compared to fluid having a reduced temperature. As one skilled in the art will appreciate, various types of nozzles (not shown) may be adapted to engage the outlet 50 to provide the desired spray pattern of the warmed fluid.

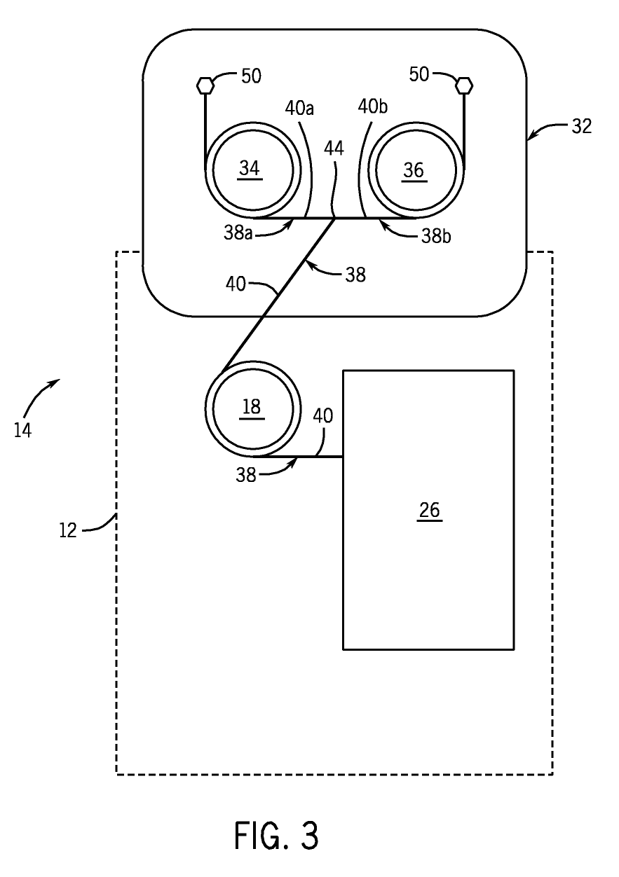

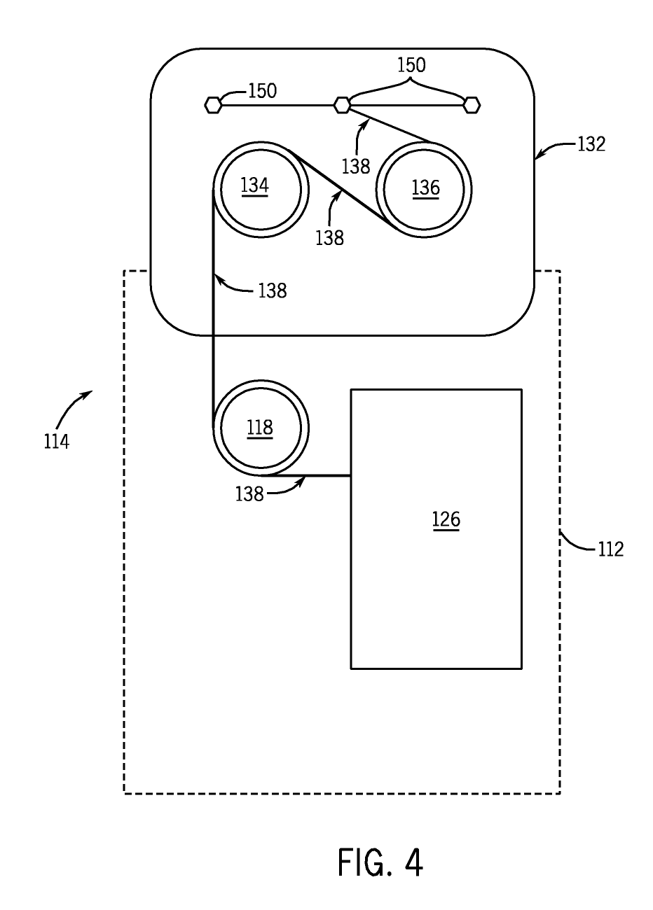

The fluid heating system 14 depicted in FIG. 2 is shown in a simplified schematic form in FIG. 3. The configuration shown in FIG. 3 includes both series and parallel passageway 38 configurations. Given the benefit of this disclosure, one skilled in the art will appreciate the variety of passageway 38 arrangements. For example, FIG. 4 is a simplified schematic of an alternative fluid heating system 114.

Turning to FIG. 4, a fluid heating system 114 similar to that depicted in FIG. 3 is shown in simplified form having a passageway 138 establishing a series fluid flow relative to the motors 118, 134, 136. The fluid, originally at an ambient temperature, flows downstream from the solution tank 126 (coupled to the frame 112) along a passageway 138 toward a drive motor 118 (or an implement motor, such as a vacuum motor). The passageway 138 brings the fluid into thermal communication with the drive motor 118 as the fluid flows along the passageway 138 proximate the drive motor 118. As with the first embodiment described, the passageway 138 may be defined in whole, or in part, by one or more conduits that are in fluid communication with the solution tank 126 and one or more outlets 150 downstream of the solution tank 126.

Continuing downstream along the passageway 138, the passageway 138 first directs the fluid into thermal communication with a first implement motor 134, mounted to a scrubber deck 132, whereat a portion of the heat generated by the first implement motor 134 is transferred to the fluid. Next, the passageway 138 is configured to bring the fluid into thermal communication with a second implement motor 136 to extract or transfer at least a portion of the heat generated by the second implement motor 136 to the fluid. The heated fluid is then directed along the passageway 138 toward three outlets 150 configured to distribute the fluid onto the surface to be cleaned.

Given the benefit of this disclosure, one skilled in the art will appreciate the variety of configuration, arrangements, and alterations of the passageway(s), motor(s), conduit(s) (if any), etc. that are within the scope of the invention. For example, and with reference to FIG. 1, when a conduit 40 is used to define a portion of the passageway 38, the conduit 40 may be at least partially encased in an insulative shell to help prevent the warmed fluid from losing a portion of its heat to the ambient environment as it flows along the passageway 38 between motors or from a motor toward an outlet.

As noted in the above example embodiments, the passageways 38, 138 may be configured such that they extend proximate to or actually engage a surface of the respective motors, thereby transferring some of the heat generated by the motors to the fluid. One skilled in the art will appreciate that the motor heat may be transferred by any mode, but is generally a combination of conduction, convection (free or forced depending upon the configuration and movement of the cleaning device 10), and radiation. Moreover, the form-factor of the cleaning device 10 and the configuration of the various motors may influence the rate and efficiency of the heat transfer from the motors to the fluid.

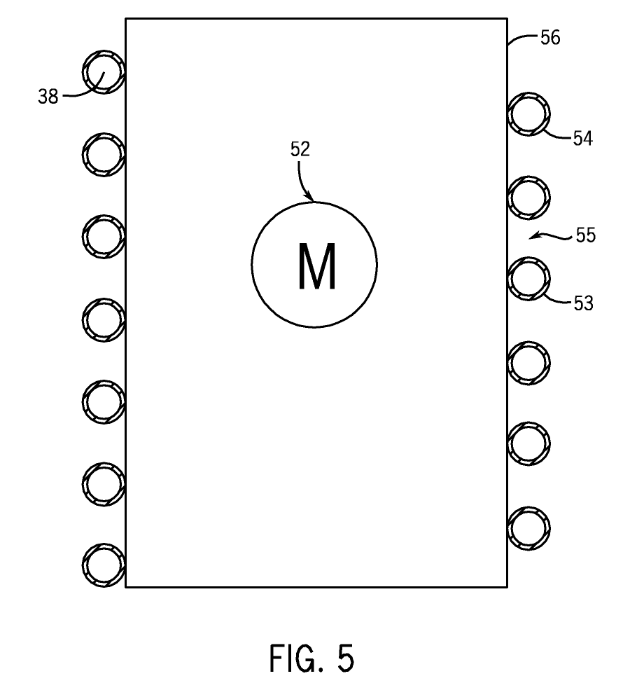

Several example configurations of the thermal communication between the passageway 38 and any type of motor 52 (i.e., drive, implement (e.g., brush, broom, scrubber, vacuum), electric, combustion, etc.) are shown in FIGS. 5-9. Turning first to FIG. 5, the passageway 38 is defined by a conduit 54 (similar to that shown in FIG. 2) configured to engage an exterior surface 56 of the motor 52. The conduit 54 has a generally circular cross-section 53 and is wrapped or coiled about the exterior surface 56 of the motor 52 such that at least a portion of the heat generated by the motor 52 is transferred through the conduit 54 and into the fluid as the fluid travels along the passageway 38. A space 55 between adjacent wraps of conduit 54 is greater than shown in FIG. 2 and may be of any preferred spacing depending upon the desired heat transfer between the motor 52 and the fluid. For example, assuming a constant flow rate of the fluid, increasing the length of passageway 38 (by increasing the length of conduit 54 shown in FIG. 5) proximate to or in contact with the exterior surface 56 of the motor 52 (e.g., by reducing the space 55 between adjacent wraps of the conduit 54) increases the time available for heat to transfer from the motor 52 to the fluid. Moreover, an increased flow rate of fluid through the passageway 38 may benefit from additional thermal communication with the motor 52 to increase the ultimate temperature of the fluid.

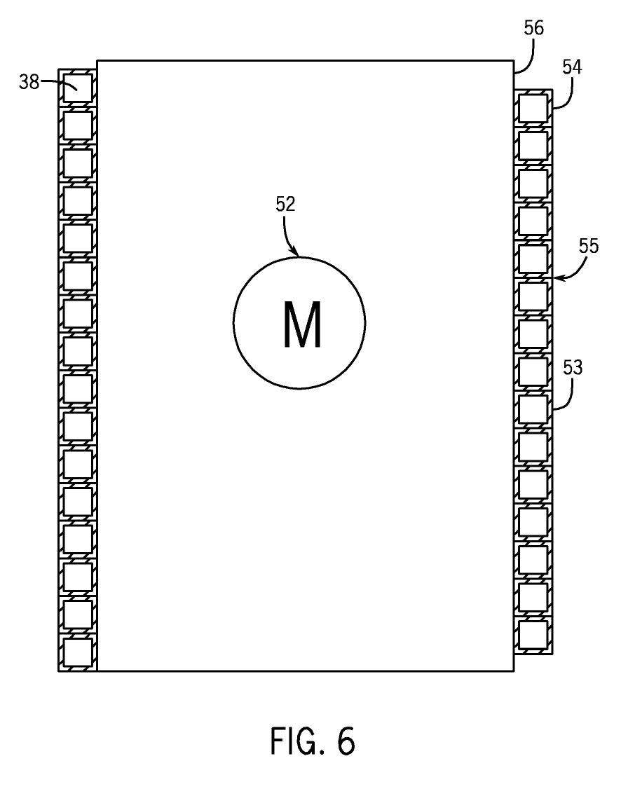

With reference to FIG. 6, the passageway 38 is defined by the conduit 54 that is configured to engage the exterior surface 56 of the motor 52, similar to the arrangement shown in FIG. 5, however, the conduit 54 has a generally square cross-section 53. The conduit 54 is wrapped or coiled about the exterior surface 56 of the motor 52 and the space 55 between adjacent portions of conduit 54 is minimized (or substantially eliminated). The basically square cross-section 53 and the reduced space 55 between adjacent portions of the conduit 54 improve the efficiency of the overall fluid heating system 14. As a result, at least a portion of the heat generated by the motor 52 is transferred through the conduit 54 and into the fluid as the fluid travels along the passageway 38.

Given the benefit of this disclosure, one skilled in the art will appreciate the various possible arrangements and configurations of the conduit 54 and passageway 38, especially when considering specific application requirements. For example, where insufficient space is available to accommodate the diameter conduit 54 shown in FIG. 5, smaller diameters and other conduits 54 with other cross-sections (e.g., rectangular, square, etc.) may be incorporated.

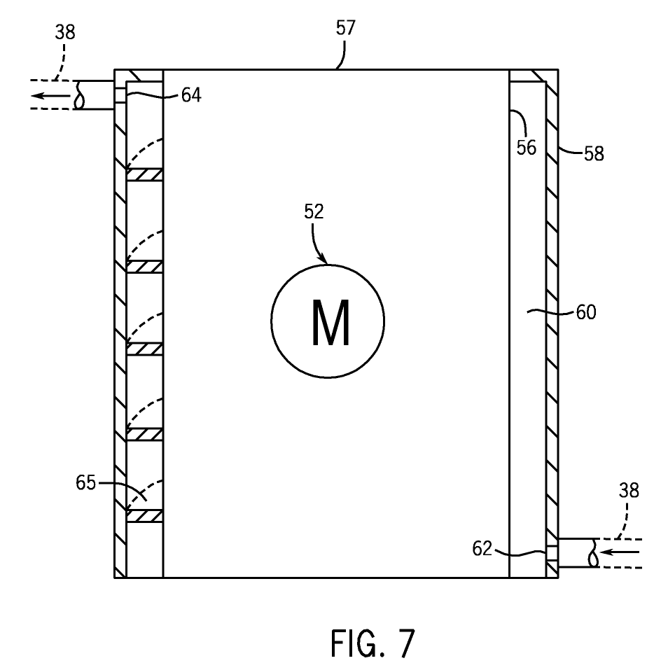

Another non-exhaustive example configuration of the thermal communication between the passageway 38 and any type of motor 52 is shown in FIG. 7. A motor jacket 58 is shown encasing a portion of the motor 52 and defines a motor passageway 60 between the jacket 58 and the exterior surface 56 of the motor 52. The passageway 38 includes the motor passageway 60 and the motor passageway 60 directs the fluid into thermal communication with the motor 52. As shown, the fluid enters the motor passageway 60 at an inlet 62 where it flows about the exterior surface 56 of the motor 52 (i.e., is in thermal communication) before exiting the motor passageway 60 at an exit 64 and continues to flow along the passageway 38 toward the outlet 50, another motor 52, or some other component.

The example jacket 58 shown in FIG. 7 is proximate the vertical portion of the exterior surface 56 and does not cover the top surface 57. However, the jacket 5 8 may be configured to encase a greater portion of the motor 52 as the application requirements allow.

The jacket 58 preferably insulates the fluid contained within the motor passageway 60 to prevent heat contained in the fluid from transferring to the ambient environment. In addition, the jacket 58 may further include a helical ramp 65 (partially shown in dashed lines on the left side of the jacket 58 of FIG. 7) that directs the fluid from the inlet 62, about the motor 52 along the motor passageway 60, and to the exit 64. The ramp 65 allows the portion of the passageway 38 along the motor passageway 60 to be further defined, thereby influencing the thermal communication between the motor 52 and the fluid. The ramp 65 may also be made of a thermally conductive material further increasing the thermal communication between the motor 52 and the fluid.

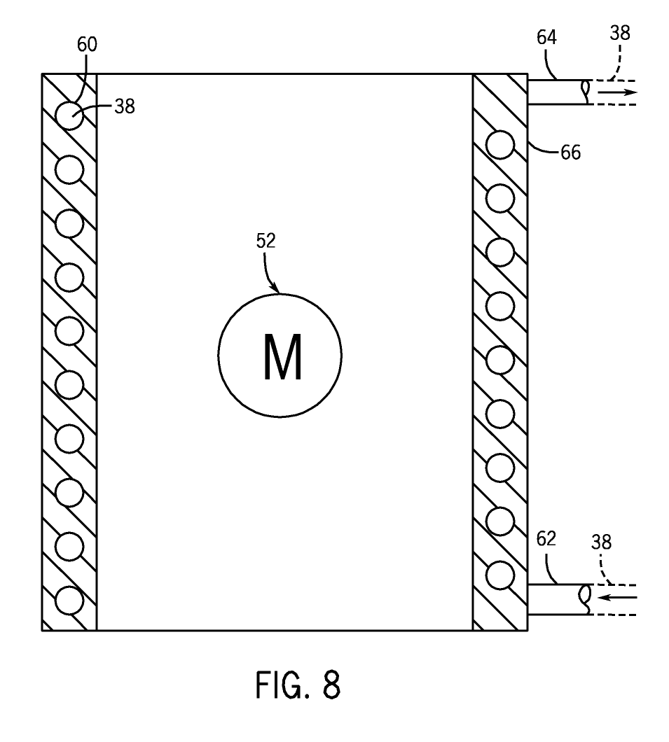

Turning next to FIG. 8, another non-exhaustive example configuration of the thermal communication between the passageway 38 and a motor 52 is depicted. In this configuration, a motor passageway 60 is integrally formed with the motor 52. Specifically, the motor 52 includes a block 66 in which the motor passageway 60 is formed (e.g., by casting or secondary drilling and plugging). As with the other example embodiments, the passageway 38 includes the motor passageway 60. The fluid flows into the motor passageway 60 proximate an inlet 62, through the motor passageway 60, and exits through the exit 64 downstream of the inlet 62. As the fluid flows along the motor passageway 60 the fluid is in thermal communication with the motor 52 and at least a portion of the heat generated by the motor 52 is transferred to the cleaning fluid, thereby raising the temperature of the fluid as it flows along the motor passageway 60.

One skilled in the art, given the benefit of this disclosure, will appreciate that the motor passageway 60 formed in the block 66 may take on a variety of configurations and arrangements. For example, the motor passageway 60 may include longitudinal passages, passages with rectangular, hexagonal, star-shaped cross-sections, and/or any combination of orientations, sizes, and patterns that achieves the desired thermal communication between the motor 52 and the fluid flowing along the passageway 38.

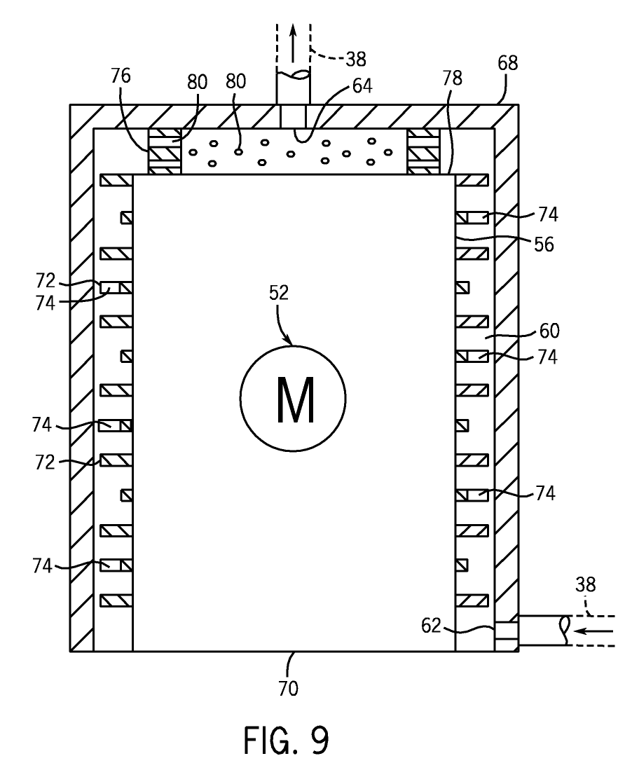

Turning next to FIG. 9, yet another non-exhaustive example configuration of the thermal communication between the passageway 38 and the motor 52 is illustrated. Similar to the example embodiment shown in FIG. 7, a jacket 68 encases the motor 52 on three sides (i.e., leaving an engagement surface 70 uncovered to allow the motor 52 to be coupled to the particular implement). Alternatively, the motor 52 may be substantially encased on all sides with an opening (not shown) that allows a drive axle (not shown) of the motor 52 to extend from the motor 52 and engage an implement.

As shown, the jacket 68 defines a motor passageway 60 substantially bounded by the exterior surface 56 of the motor 52 and the jacket 68. A series of annular fins 72 are vertically spaced apart and extend from the exterior surface 56. The fins 72 are of varying width and may alternatively extend from the jacket 68, or some combination of the jacket 68 and the exterior surface 56, and may be of varying thickness. The fins 72 aid the transfer of heat from the motor 52 to the fluid (i.e., thermal communication). The fluid may enter the motor passageway 60 at the inlet 62 where it flows around and through the fins 72. The fins 72 are shown of varying length and include notches 74 that may be included to adjust the flow of fluid (and thus overall thermal communication) through the motor passageway 60. Additionally, the example embodiment includes a ring 76 located proximate the top surface 78 of the motor 52. The ring 76 includes a plurality of ports 80 formed therein that direct the fluid through the ports 80 as the fluid flows along the passageway 38, again increasing the thermal communication before the fluid continues to flow downstream through the exit 64 and along the balance of the passageway 38. As with the other examples, the jacket 68 may be insulated (not shown) to prevent heat generated by the motor 52 and transferred to the fluid from being transferred to the ambient environment. In view of this disclosure, one skilled in the art will appreciate the various alterations and arrangements that are within the scope of the claims.

The components that are placed in thermal communication (e.g., conduits 54, exterior surfaces 56, blocks 66, fins 72, rings 76, etc.) preferably include a portion of a thermally conductive material, such as copper or aluminum, to enhance the thermal communication and reduce the thermal resistance. Additionally, thermally conductive grease, gel, or another intermediary may be added between the components that are to exchange heat, thereby increasing the rate of heat transfer. Insulation may also be incorporated proximate the passageway 38 and other components to retain heat in the fluid as it travels along the passageway 38 before ultimately being directed from the outlet(s) 50. One skilled in the art will appreciate that typical heat transfer techniques are equally applicable to establish thermal communication between a motor and the fluid such that the fluid directed through the passageway 38 is heated as it flows through the passageway 38.

The change in temperature of the fluid achieved as it flows through the passageway 38 depends upon a variety of factors, including, for example, the flow rate of the fluid, the temperature difference between the flowing fluid and the various motors, the conductivity and surface area of any heat transfer components, the heat generated by the various motors, the effectiveness of any insulating materials, and the temperature of the ambient environment. One skilled in the art will appreciate the various factors that impact the ultimate thermal communication between the motor(s) and the fluid. Moreover, the desired temperature of the fluid when it is directed onto the surface to be cleaned may vary depending upon the application requirements.

While there has been shown and described what is at present considered the preferred example embodiments, it will be obvious to those skilled in the art that various changes and modifications can be made therein without departing from the scope of the invention defined by the following claims.

We claim:

1. A cleaning device, comprising:
a frame;
a tank carried by the frame and containing a cleaning fluid;
a first motor capable of generating a first motor heat;
a passageway in fluid communication with the tank and in thermal communication with the first motor to transfer at least a portion of the first motor heat to the cleaning fluid when the cleaning fluid is directed downstream from the tank along the passageway; and
an outlet in fluid communication with the passageway and downstream of the first motor for directing the cleaning fluid onto a surface to be cleaned.

2. The cleaning device of claim 1, further comprising:
a second motor capable of generating a second motor heat;
wherein the passageway is in thermal communication with the second motor to transfer at least a portion of the second motor heat to the cleaning fluid when the cleaning fluid is directed downstream from the tank along the passageway; and
wherein the outlet is downstream of the second motor.

3. The cleaning device of claim 1, wherein the first motor is at least one of a drive motor and an implement motor.

4. The cleaning device of claim 1, wherein the passageway further comprises:
a conduit in fluid communication with the tank and the outlet;
wherein the conduit is configured to engage an exterior surface of the first motor.

5. The cleaning device of claim 4, wherein:
the conduit defines a substantially square cross-section; and
the conduit is arranged such that a space between adjacent portions of the conduit is minimal.

6. The cleaning device of claim 1, further comprising:
a first motor jacket at least partially encasing the first motor and defining a first motor passageway;
wherein the passageway includes the first motor passageway.

7. The cleaning device of claim 1, further comprising:
a first motor passageway integrally formed in the first motor;
wherein the passageway includes the first motor passageway.

8. A cleaning device, comprising:
a frame;
a deck operationally coupled to the frame;
a tank carried by the frame and containing a cleaning fluid;
a first motor capable of generating a first motor heat;
a passageway in fluid communication with the tank and in thermal communication with the first motor to transfer at least a portion of the first motor heat to the cleaning fluid when the cleaning fluid is directed downstream from the tank along the passageway; and
an outlet in fluid communication with the passageway and downstream of the first motor for directing the cleaning fluid onto a surface to be cleaned.

9. The cleaning device of claim 8, further comprising:
a second motor capable of generating a second motor heat;
wherein the passageway is in thermal communication with the second motor to transfer at least a portion of the second motor heat to the cleaning fluid when the cleaning fluid is directed downstream from the tank along the passageway; and
wherein the outlet is downstream of the second motor.

10. The cleaning device of claim 9, further comprising:
a third motor fixed relative to the deck and capable of generating a third motor heat;
wherein the passageway is in thermal communication with the third motor to transfer at least a portion of the third motor heat to the cleaning fluid when the cleaning fluid is directed downstream from the tank along the passageway.

11. The cleaning device of claim 10, wherein:
the first motor is fixed relative to the frame; and
the second motor is fixed relative to the deck;
wherein the first motor is upstream of the second motor and the third motor.

12. The cleaning device of claim 11, wherein:
the first motor is an electric drive motor;
the second motor is a first electric implement motor; and
the third motor is a second electric implement motor.

13. The cleaning device of claim 12, further comprising:
a second outlet in fluid communication with the passageway;
wherein the outlet is downstream of the first motor and the first electric implement motor; and
wherein the second outlet is downstream of the first motor and the second electric implement motor.

14. The cleaning device of claim 8, wherein the passageway further comprises:
a conduit in fluid communication with the tank and the outlet;
wherein the conduit is configured to engage an exterior surface of the first motor.

15. The cleaning device of claim 14, wherein:
the conduit defines a substantially square cross-section; and
the conduit is arranged such that a space between adjacent portions of the conduit is minimal.

16. The cleaning device of claim 8, further comprising:
a first motor jacket at least partially encasing the first motor and defining a first motor passageway;
wherein the passageway includes the first motor passageway.

17. The cleaning device of claim 8, further comprising:
a first motor passageway integrally formed in the first motor;
wherein the passageway includes the first motor passageway.

18. A method of cleaning a surface with a cleaning device having a frame, a tank carried by the frame and containing a cleaning fluid, a motor capable of generating a motor heat, a passageway in fluid communication with the tank and in thermal communication with the motor, and an outlet in fluid communication with the passageway and downstream of the motor, comprising the step of transferring at least a portion of the motor heat to the cleaning fluid as the cleaning fluid flows downstream from the tank along the passageway.

19. The method of claim 18, further comprising the step of directing the cleaning fluid through the outlet onto the surface.

20. The method of claim 18, wherein the cleaning device has a second motor capable of generating a second motor heat and wherein the passageway is in thermal communication with the second motor, further comprising the step of transferring at least a portion of the second motor heat to the cleaning fluid as the cleaning fluid flows downstream from the tank along the passageway.
